(19) United States
(12) Patent Application Publication
(10) Pub. No.: US 2015/0309538 A1
(43) Pub. Date: Oct. 29, 2015

(54) FOLDABLE KEYBOARD

(71) Applicant: CHANGSHU SUNREX TECHNOLOGY CO., LTD., Changshu (CN)

(72) Inventor: Qing ZHANG, Changshu (CN)

(73) Assignee: CHANGSHU SUNREX TECHNOLOGY CO., LTD., Changshu (CN)

(21) Appl. No.: 14/262,302

(22) Filed: Apr. 25, 2014

(51) Int. Cl. G06F 1/16

(52) U.S. Cl. CPC G06F 1/1662; G06F 1/1684

(57) ABSTRACT

A foldable keyboard includes a casing and a plurality of input modules. The casing includes interconnected top and bottom sheets. Each of the top and bottom sheets is made of a flexible material. The top and bottom sheets cooperatively define a plurality of retaining spaces that are spaced apart from each other, and cooperatively form a plurality of foldable sections each being disposed between two adjacent ones of the retaining spaces. The input modules are retained respectively in the retaining spaces.

### BACKGROUND OF THE INVENTION

1. Field of the Invention

The invention relates to a keyboard, more particularly to a foldable keyboard.

2. Description of the Related Art

A conventional standard keyboard is the most practical input device for computer systems. Recently, although portable electronic devices, such as smart phone, personal digital assistant (PDA), tablet computer and electronic paper, become ubiquitous, the conventional standard keyboard is still needed when a large number of input operations are required. However, the conventional standard keyboard is not easily carried along with the portable electronic devices because of its dimension.

Referring to FIG. 1, another conventional keyboard-disclosed in Taiwanese Publication No. M419143 (Application No. 100211373) includes left and right keyboard modules 91, 92, a seat member 93, a pair of bolts 96, a plurality of auxiliary plates 94 and a plurality of pins 95. The left and right keyboard modules 91, 92 are connected pivotally to tire seat member 93 by the bolts 96. The auxiliary plates 94 are connected pivotally between the left and right keyboard modules 91, 92 and the seat member 93 by the pins 95. The left and right keyboard modules 91, 92 are operable to pivot relative to each other such that the conventional keyboard is foldable and is easily carried. However, the structure and assembly of the conventional keyboard disclosed in Taiwanese Publication No. M419143 are more complex than those of the conventional standard keyboard, and the pivotally-connected portions of the conventional keyboard in Taiwanese Publication No. M419143 are easily worn off.

### SUMMARY OF THE INVENTION

Therefore, the object of the present invention is to provide a foldable keyboard that has a simple structure.

Accordingly, a foldable keyboard of the present invention includes a casing and a plurality of input modules. The casing includes interconnected top and bottom sheets. Each of the top and bottom sheets is made of a flexible material. The top and bottom sheets cooperatively define a plurality of retaining spaces that are spaced apart from each other, and cooperatively form a plurality of foldable sections each being disposed between two adjacent ones of the retaining spaces. The input modules are retained respectively in the retaining spaces.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional keyboard disclosed in Taiwanese Publication No. M419143;

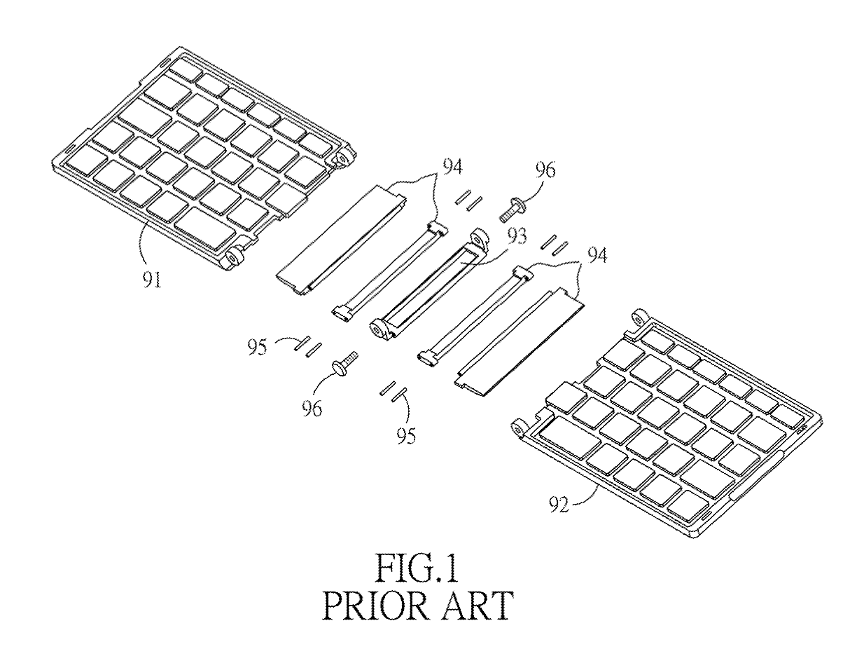

FIG. 2 is an exploded perspective view of a preferred embodiment of a foldable keyboard according to the invention;

FIG. 3 is a perspective view of the preferred embodiment;

FIG. 4 is a fragmentary sectional view of the preferred embodiment;

FIG. 5 is a fragmentary top view of the preferred embodiment;

FIG. 6 is a schematic perspective view illustrating how the preferred embodiment is folded; and

FIG. 7 is another schematic perspective view illustrating that the preferred embodiment is folded, into a support frame for supporting a tablet computer.

### DETAILED DESCRIPTION OF THE PREFERRED EMBODIMENT

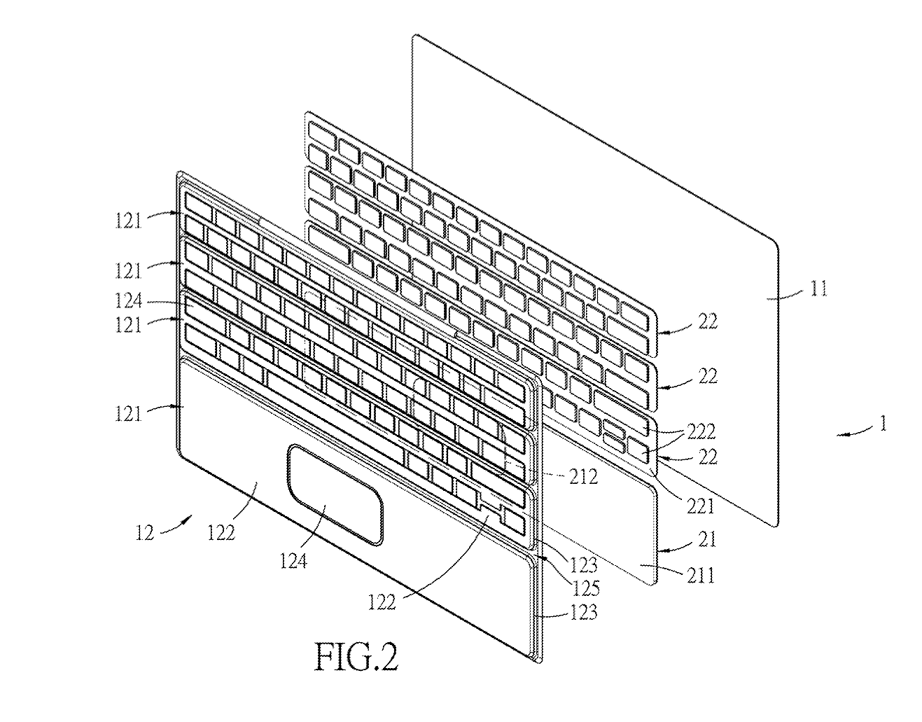

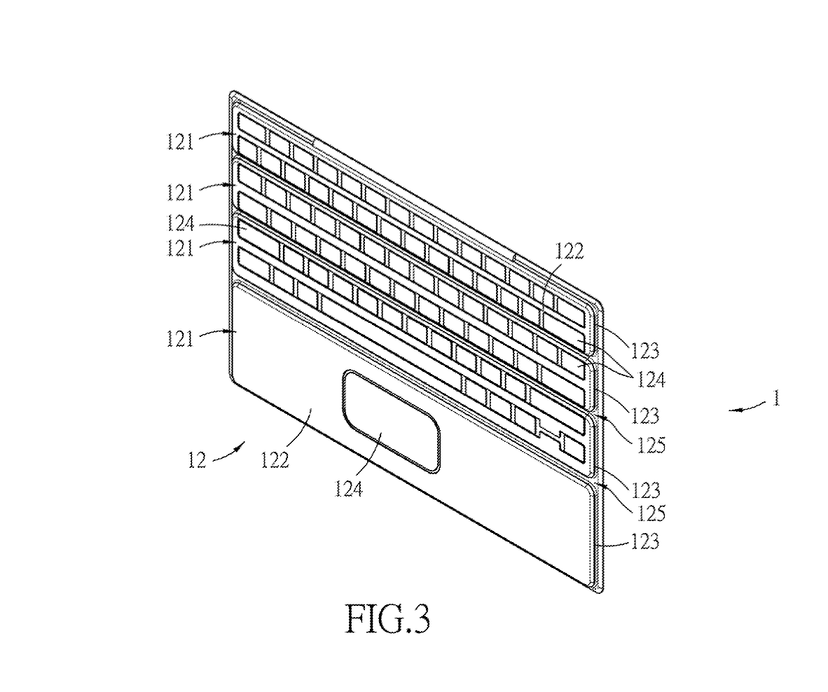

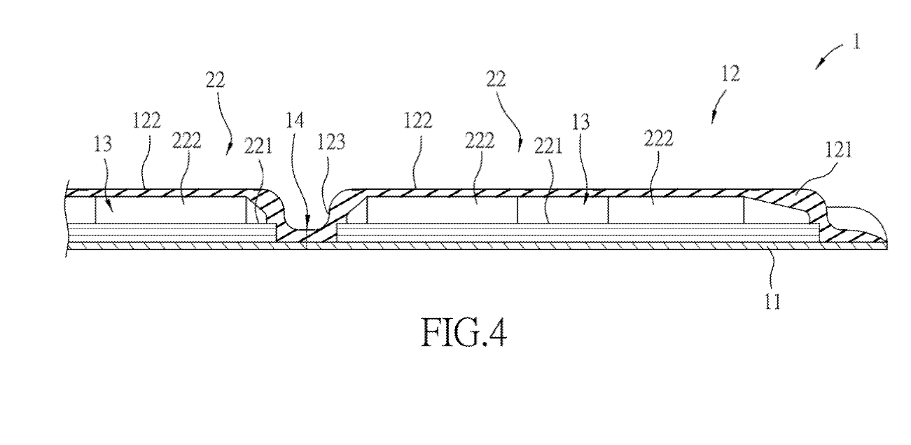

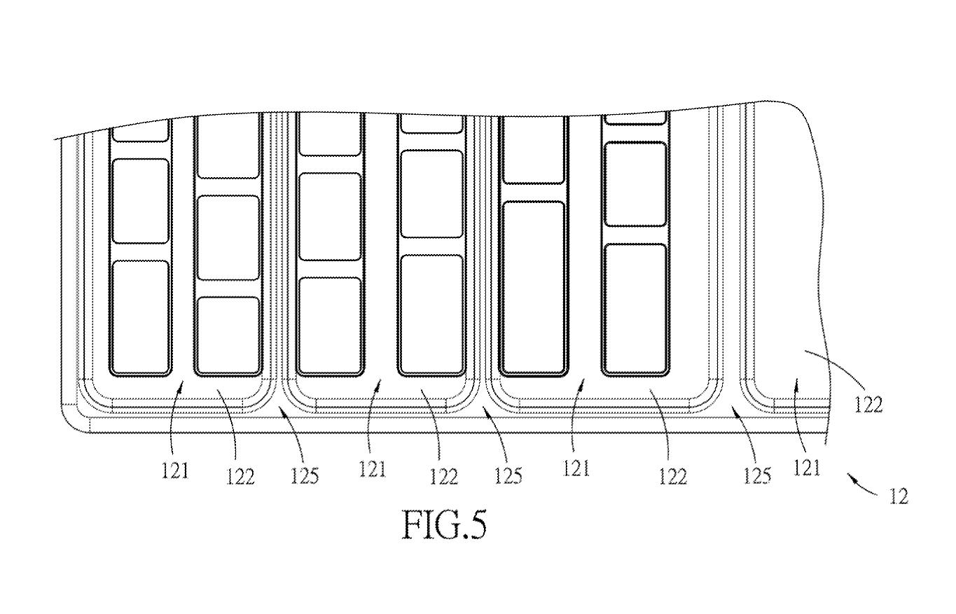

As shown in FIGS. 2 to 5, a preferred embodiment of a foldable keyboard according to the present invention includes a casing 1 and font input modules 21, 22. The casing 1 is made of a flexible material, such as leather or a leatherlike material (e.g., polyurethane or silicone). The mechanical property of polyurethane or silicone could be varied in a wide range, so that the casing 1 made of polyurethane or silicone may have a better flexibility.

The casing 1 includes a fop sheet 12 and a bottom sheet 11 that are interconnected. Each of the top sheet 12 and the bottom sheet 11 is substantially rectangular and is configured as a single piece. The top sheet 12 and bottom sheet 11 cooperatively define four retaining spaces 13 that are spaced apart from each other in a direction, and cooperatively form three foldable sections 14 each being disposed between two adjacent ones of the retaining spaces 13.

The top sheet 12 has four retaining segments 121 and three foldable segments 125, Each of the retaining segments 121 has a top wall 122 that is spaced apart from the bottom sheet 11, and a surrounding wall 123 that extends from a periphery of the top wall 122 toward the bottom sheet 11. Each of the foldable segments 125 is connected between two adjacent ones of the surrounding walls 123 of the retaining segments 121. The retaining segments 121 cooperate with the bottom sheet 11 to define the retaining spaces 13. The foldable segments 125 cooperate with the bottom sheet 11 to form the foldable sections 14.

The input modules 21, 22 are retained fittingly and respectively in the retaining spaces 13. The input modules 21, 22 include one touch-type input module 21 and three press-type input modules 22. The touch-type input module 21 has a base board 211 that has a circuit unit (not shown), and a touch panel 212 that is provided on the base board 211 of the touch-type input module 21. Each of the press-type input module 22 has a base board 221 that has a circuit unit (not shown) and a plurality of press keys 222 that are provided on the base board 221 of the press-type input module 22. In this embodiment, the input modules 21, 22 are coupled wirelessly to each other, and the foldable keyboard is coupled wirelessly to a computing device (e.g., a personal computer or a tablet computer).

The top wall 122 of each of the retaining segments 121 of the top sheet 12 is formed with a plurality of patterns 124. The patterns 124 of the retaining segments 121 of the top sheet 12 are aligned respectively with the touch panel 212 and the press keys 222. The top sheet 12 may be made of leather having different colors for visual demands, or may be made of a microfiber material for different tactile feeling.

It is noted that the top sheet 12 is first formed by a heat press machine (not shown). Then the top and bottom, sheets 12, 11 are adhered to the input modules 21, 22 such that the input modules 21, 22 are concealed between the top and bottom sheets 12, 11.

In this embodiment, the number of the input modules 21, 22 is four, the number of the retaining spaces 13 is four, and the number of the foldable sections 14 is three. In another embodiment, the number of the input modules 21, 22 may be three, the number of the retaining spaces 13 may be three, and the number of the foldable sections 14 is therefore two. In still another embodiment, the number of the input modules 21, 22 may be five, the number of the retaining spaces 13 may be five, and the number of the foldable sections 14 is therefore four. In addition, the casing 1 may be made of a flexible material other than polyurethane or silicone.

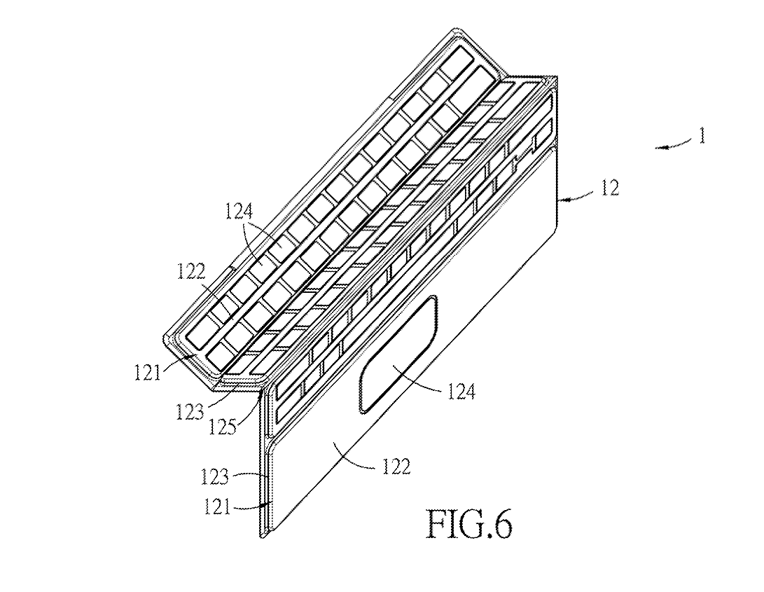

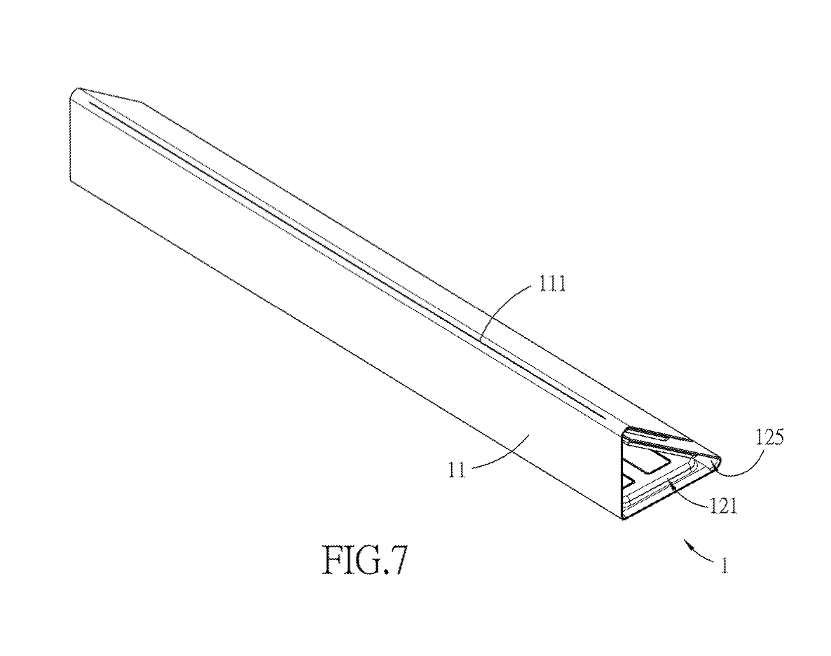

Referring to FIGS. 6 and 7, the foldable keyboard of this invention may be used with a tablet computer (not shown). Besides serving as an input device, the foldable keyboard may be folded to serve as a protection cover for the tablet computer, or may be folded to serve as a support frame (see FIG. 7) for the tablet computer.

It is noted that the bottom sheet 11 is formed with three creases 111 (only one is shown in FIG. 7) that correspond respectively in position to the foldable segments 125 of the top sheet 12 to facilitate fold of the foldable keyboard.

To sum up, since each of the top sheet 12 and the bottom sheet 11 is made of a flexible material and is configured as a single piece, the foldable keyboard of this invention has a structure simpler than that of the conventional keyboard disclosed in Taiwanese Publication No. M419143.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A foldable keyboard comprising:
a casing including interconnected top and bottom sheets, each of said top and bottom sheets being made of a flexible material, said top and bottom sheets cooperatively defining a plurality of retaining spaces that are spaced apart from each other, and cooperatively forming a plurality of foldable sections each being disposed between two adjacent ones of said retaining spaces; and
a plurality of input modules retained respectively in said retaining spaces.

2. The foldable keyboard as claimed in claim 1, wherein said top sheet of said casing has a plurality of retaining segments and a plurality of foldable segments, each of said retaining segments having a top wall that is spaced apart from said bottom sheet, and a surrounding wall that extends from a periphery of said top wall toward said bottom sheet, each of said foldable segments being connected between two adjacent ones of said surrounding walls of said retaining segments, said retaining segments cooperating with said bottom sheet to define said retaining spaces, said foldable segments cooperating with said bottom sheet to form said foldable sections.

3. The foldable keyboard as claimed in claim 2, wherein said retaining segments of said top sheet are spaced apart from each other in a direction.

4. The foldable keyboard as claimed in claim 3, wherein said casing is made of leather or a leather like material.

5. The foldable keyboard as claimed in claim 4, wherein said input modules includes at least one touch-type input module and at least one press-type input module, said touch-type input module having a base board and a touch panel that is provided on said base board of said touch-type input module, said press-type input module having a base board and a plurality of press keys that are provided on said base board of said press-type input module.

6. The foldable keyboard as claimed in claim 5, wherein said top wall of each of said retaining segments of said top sheet is formed with patterns, said patterns of said retaining segments of said top sheet being aligned respectively with said touch panel and said press keys.

7. The foldable keyboard as claimed in claim 1, wherein each of said top and bottom sheets is configured as a single piece.
